(19) United States
(12) Patent Application Publication
(10) Pub. No.: US 2017/0314640 A1
(43) Pub. Date: Nov. 2, 2017

(54) INERTIA FLYWHEEL ASSEMBLY AND SYSTEM THEREOF

(71) Applicant: INFINIFORCE, INC., Wilmington, DE (US)

(72) Inventor: MING-CHEN LIAO, WILMINGTON, DE (US)

(21) Appl. No.: 15/581,281

(22) Filed: Apr. 28, 2017

(30) Foreign Application Priority Data
Apr. 28, 2016 (TW) 105113313

(51) Int. Cl. F16F 15/30

(52) U.S. Cl. CPC F16F 15/30

(57) ABSTRACT

An inertia flywheel assembly and a system thereof are disclosed. The inertia flywheel assembly of the present invention comprises at least one inertia flywheel and at least one transmission member. The inertia flywheel has a flywheel body and an axle core, and the flywheel body could spin via the axle core. The axle core is fixed to the axis of the flywheel body. The at least one transmission member is coupled to the axle core. The flywheel body is an arc-shaped plate, which has a first curved surface and a second curved surface. The tangent planes of the first curved surface and the second curved surface include an angle.

### BACKGROUND

### Technical Field

The present invention relates to a power transmission assembly and a system thereof, and in particular, to an inertia assembly and a system thereof which enhance the efficiency of energy applications.

### Related Art

The present invention provides an inertia assembly which cooperates with conventional dynamic systems and power systems. For example, the present invention cooperates with conventional power systems, such as wind drive power generator, hydraulic power generator, solar cell power generator, renewable energy power generator, etc.

For thermal power generator and hydraulic power generator, energy is continuously provided to generate mechanical energy, and then the mechanical energy is transferred to electric power for public application. The power transmission assembly of conventional dynamic system consumes a lot of energy during transmission. That is not economic and environment friendly.

In the present invention, the inertia flywheel assembly is associated with a driving device. When the rotating speed of the inertia flywheel assembly is raised to a rated revolution, the output power of the driving device is reduced. Consequently, the energy consumption is reduced.

### SUMMARY

An objective of the present invention is to provide a power transmission assembly and a system thereof, and in particular, to an inertia assembly and a system thereof which enhance the efficiency of energy applications.

The present invention provides an inertia flywheel assembly, comprising: at least one inertia flywheel having a flywheel body and a axle core, wherein the axle core is fixed to an axis of the flywheel body and the flywheel body could spin via the axle core; and at least one transmission member coupled to the axle core of one of the least one inertia flywheel; wherein the flywheel body is an arc-shaped plate with a first curved surface and a second curved surface, each curved surface has a tangent plane and the two tangent planes include an angle.

In an embodiment of the present invention, the angle is between 5 degree and 70 degree.

In an embodiment of the present invention, the angle is between 10 and 40 degree.

In an embodiment of the present invention, the at least one transmission member comprises a first transmission member, the at least one inertia flywheel comprises a first inertia flywheel and a second inertia flywheel, and the first inertia flywheel is coupled to the second inertia flywheel by the first transmission member.

In an embodiment of the present invention, the first inertia flywheel and the second inertia flywheel are configured to be coaxial or uncoaxial.

In an embodiment of the present invention, the at least one transmission member comprises a first transmission member and a second transmission member, the at least one inertia flywheel comprises a first inertia flywheel, a second inertia flywheel and a third inertia flywheel, and the first inertia flywheel is coupled to the second inertia flywheel and the third inertia flywheel by the first transmission member and the second transmission member respectively.

In an embodiment of the present invention, the first inertia flywheel, the second inertia flywheel and the third inertia flywheel are configured to be partially coaxial, coaxial or uncoaxial.

In an embodiment of the present invention, the at least one transmission member comprises a plurality of transmission members, the at least one inertia flywheel comprises a plurality of inertia flywheels, and the plurality of inertia flywheels are coupled by the plurality of transmission members.

In an embodiment of the present invention, the transmission member is belt pulley set, chain pulley set or gear set.

In an embodiment of the present invention, the flywheel body is a monolithic metal member or composed of a plurality of sheet materials.

In an embodiment of the present invention, the flywheel body has a diameter and a thickness, and the diameter is greater than the thickness.

The present invention further provides a system of inertia flywheel assembly, comprising: at least one driving device; the inertia flywheel assembly as claimed in claim 1 connected to the at least one driving device; and at least one output device connected to the inertia flywheel assembly.

In an embodiment of the present invention, the at least one driving device is directly connected to one inertia flywheel of the inertia flywheel assembly.

In an embodiment of the present invention, the at least one driving device, the inertia flywheel assembly and the at least one output device are integrated to a single member.

In an embodiment of the present invention, the at least one output device comprises a plurality of output devices.

In an embodiment of the present invention, the system further comprises an electrical control unit.

In an embodiment of the present invention, the system further comprises a system monitor unit for monitoring a status of the at least one driving device, the inertia flywheel assembly and the at least one output device.

In an embodiment of the present invention, the system further comprises an abort unit connected to the system monitor unit, wherein when the system monitor unit transmits an anomalous signal to the abort unit, the abort unit transmits an abort signal to the at least one driving device or directly stop the inertia flywheel assembly.

In an embodiment of the present invention, the system further comprises a plurality of dampers.

In an embodiment of the present invention, the system further comprises at least one flywheel monitor unit configured to detect the rotating speed of the at least one inertia flywheel in the inertia flywheel assembly. The driving device includes a controller for controlling an output of the driving device, and the controller controls the driving device to provide an initial output to start the inertia flywheel assembly. When a rotating speed of the inertia flywheel in the inertia flywheel assembly is raised to a rated revolution, the flywheel monitor unit transmits an adjusting signal to the controller to adjust the output of the driving device.

### BRIEF DESCRIPTION OF THE DRAWINGS

The disclosure will become more fully understood from the detailed description given herein below for illustration only, and thus are not limitative of the disclosure, and wherein:

FIG. 1 is a schematic diagram of an inertia flywheel in accordance with one embodiment of the present invention.

FIG. 2 is a sectional view of the inertia flywheel in accordance with the embodiment shown in FIG. 1.

FIG. 3 is a schematic diagram of an inertia flywheel assembly in accordance with one embodiment of the present invention.

FIG. 4 is a schematic diagram of an inertia flywheel assembly in accordance with another embodiment of the present invention.

FIG. 5 is a schematic block diagram of a system of inertia flywheel assembly in accordance with one embodiment of the present invention.

FIG. 6 is a schematic diagram of a system in accordance with one embodiment of the system shown in FIG. 5.

FIG. 7 is a schematic diagram of a system in accordance with another embodiment of the system shown in FIG. 5.

FIG. 8 is a schematic diagram of a system in accordance with still another embodiment of the system shown in FIG. 5.

FIG. 9 is a schematic diagram of a system in accordance with still another embodiment of the system shown in FIG. 5.

### DETAILED DESCRIPTION

In the present specification, elements or devices with the same number comprise the same or similar configurations or functions. For better understanding, some conventional elements are omitted in the drawings. For example, bearings are not shown in the drawings that do not bother a person who is skilled in the art to understand the present invention.

The present invention discloses an inertia assembly which cooperates with conventional dynamic systems and power systems. Since the inertia assembly maintains a constant angular momentum after starting, the input energy is greatly reduced. The inertia flywheel assembly of the present embodiment comprises at least one inertia flywheel and at least one transmission member. The amounts of the inertia flywheels and the transmission members are dependent to the requirement of the system.

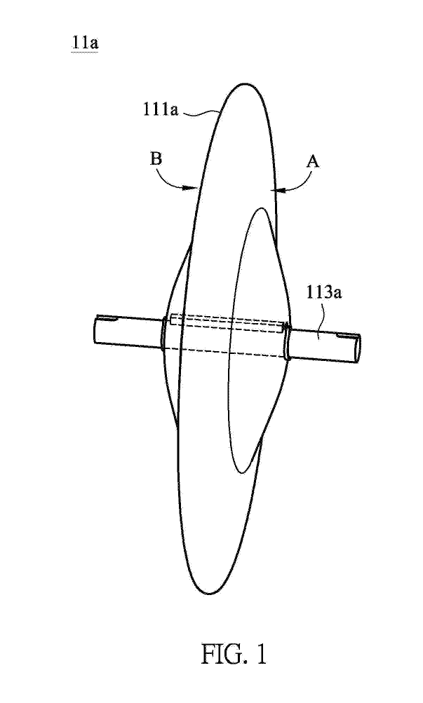

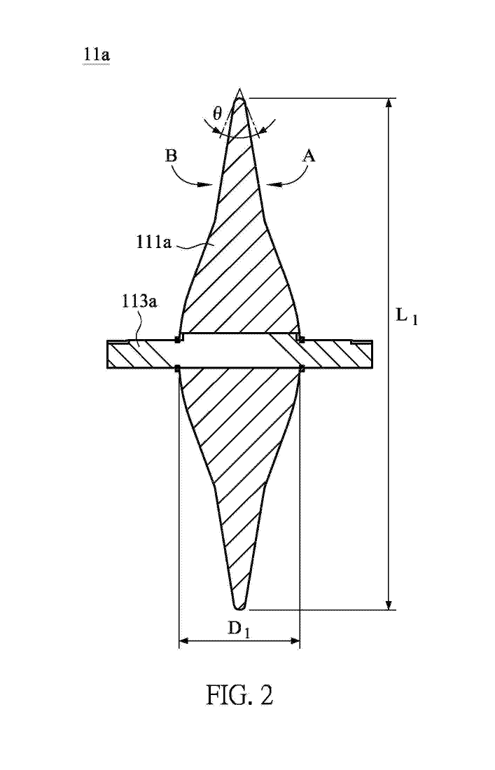

Referring to FIG. 1 and FIG. 2, there are shown a schematic diagram and a sectional view of an inertia flywheel in accordance with one embodiment of the present invention. The inertia flywheel 11a includes a flywheel body 111a and an axle core 113a, and the flywheel body 111a could spin via the axle core 113a. The axle core 113a is fixed to the axis of the flywheel body 111a. If the inertia flywheel 11a is associated with a transmission member, the transmission member is associated to the axle core 113a and is coupled to the axle core 113 to transmit mechanical energy.

In particular, the flywheel body 111a is an arc-shaped plate with a buckled center portion and a flat surrounding portion. For example, the thickness of the flywheel body 111a decreases from the center to the circumference. The diameter L1 of the flywheel body 111a is greater than the thickness D1 of the flywheel body 111a. The surface of the flywheel body 111a is streamlined. Furthermore, the flywheel body can be monolithic metal member or composed of a plurality of metal sheets. In general, the conventional flywheel has a design contrary to the present invention. Most of the mass of the conventional flywheel is distributed on the circumference. Comparing to the conventional design, the inertia flywheel of the present invention has greater inertia mass.

The flywheel body 111a has a first curved surface A and a second curved surface B. The tangent planes of the first curved surface A and the second curved surface B include an angle θ. The angle θ is between 5 degree and 70 degree. More preferably, the angle θ is between 10 degree and 40 degree. In an embodiment of the present invention, the flywheel body 111a has a diameter of 74 cm and weight of 220 kg. The size, material and weight of the flywheel body 111a can be modified according to the requirements.

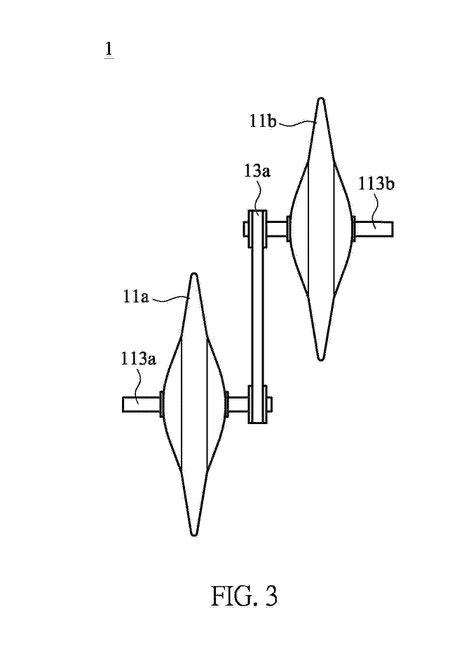

Referring to FIG. 3, there is shown a schematic diagram of an inertia flywheel assembly in accordance with one embodiment of the present invention. The present embodiment comprises two inertia flywheels and a transmission member.

In particularly, the inertia flywheel assembly 1 of the present embodiment comprises a first inertia flywheel 11a, a second inertia flywheel 11b and a first transmission member 13a. The first inertia flywheel 11a drives the second inertia flywheel 11b by the first transmission member 13a. The first transmission member 13a is belt pulley set, chain pulley set, gear set or other equivalent mechanical energy transmission member.

In application, a motor is used to drive the first inertia flywheel 11a on the first axle core 113a to overcome the static friction force and start to spin. For adjusting the rotating speed of the motor, an electronic or mechanical controller is connected to the motor. The first axle core 113a drives the transmission member 13a to operate. Since the transmission member 13a is coupled to the first axle core 113a and the second axle core 113b, the second inertia flywheel 11b is driven to overcome the static friction force and start to spin.

In the present embodiment, the first inertia flywheel 11a and the second inertia flywheel 11b are configured to be uncoaxial, but in the other embodiment they may be configured to be coaxial, that should not be the limitations of the present invention.

In the present embodiment, the second inertia flywheel 11b has the same or similar structures with the first inertia flywheel 11a.

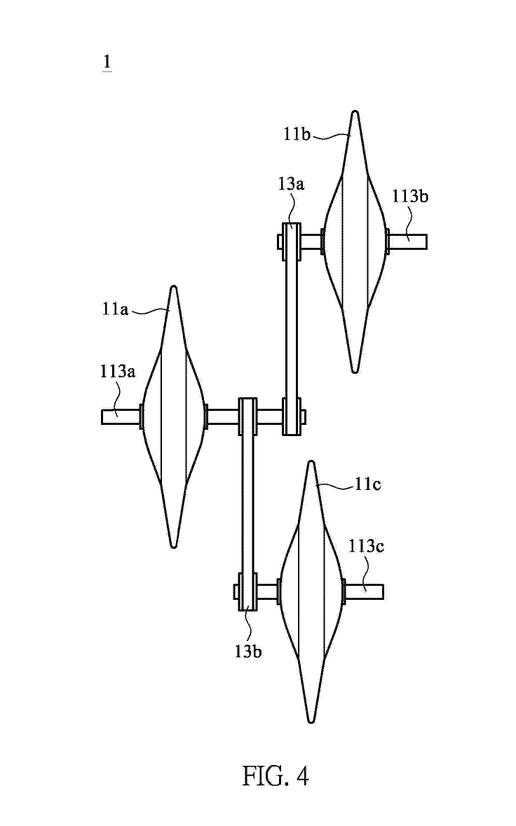

Referring to FIG. 4, there is shown a schematic diagram of an inertia flywheel assembly in accordance with another embodiment of the present invention. The present embodiment comprises three inertia flywheels and two transmission members.

The inertia flywheel assembly 1 of the present embodiment comprises a first inertia flywheel 11a, a second inertia flywheel 11b, a third inertia flywheel 11c, a first transmission member 13a and a second transmission member 13b. Similarly, the first inertia flywheel 11a drives the second inertia flywheel 11b by the first transmission member 13a and drives the third inertia flywheel 11c by the second transmission member 13b. In the other embodiment, the third inertia flywheel 11c may be driven by the second inertia flywheel 11b via the second transmission member 13b. In other words, the first inertia flywheel 11a drives the second inertia flywheel 11b, and the second inertia flywheel 11b drives the third inertia flywheel 11c.

In the present embodiment, the first inertia flywheel 11a, the second inertia flywheel 11b and the third inertia flywheel 11c are configured to be uncoaxial, but in the other embodiment they may be configured to be partially coaxial, coaxial or uncoaxial, that should not be the limitations of the present invention. Moreover, the mass of the first inertia flywheel 11a is greater than the masses of the second inertia flywheel 11b and the third inertia flywheel 11c. It is easier for the first inertia flywheel 11a to drive the second and third inertia flywheels 11b, 11c.

In the present embodiment, the third inertia flywheel 11c has the same or similar structures with the first and the second inertia flywheels 11a, 11b and the second transmission member 13b has the same or similar structures with the first transmission member 13a.

Although FIGS. 1-4 illustrate embodiments with one to three inertia flywheels, that are not the limitations of the present invention. The amounts of the inertia flywheels and the transmission members are dependent to the requirements.

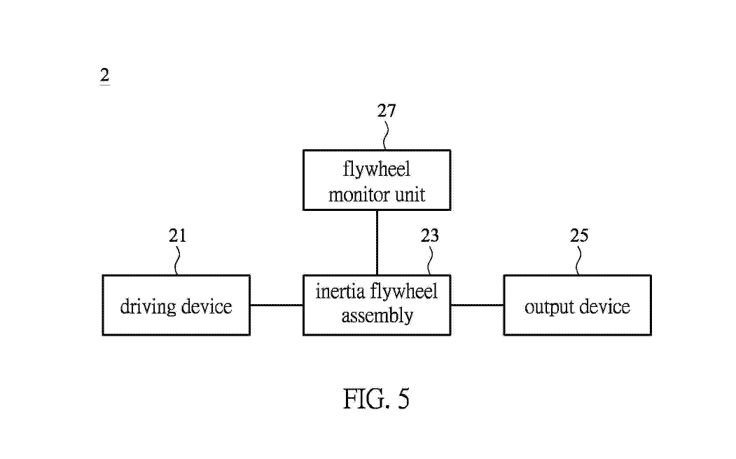

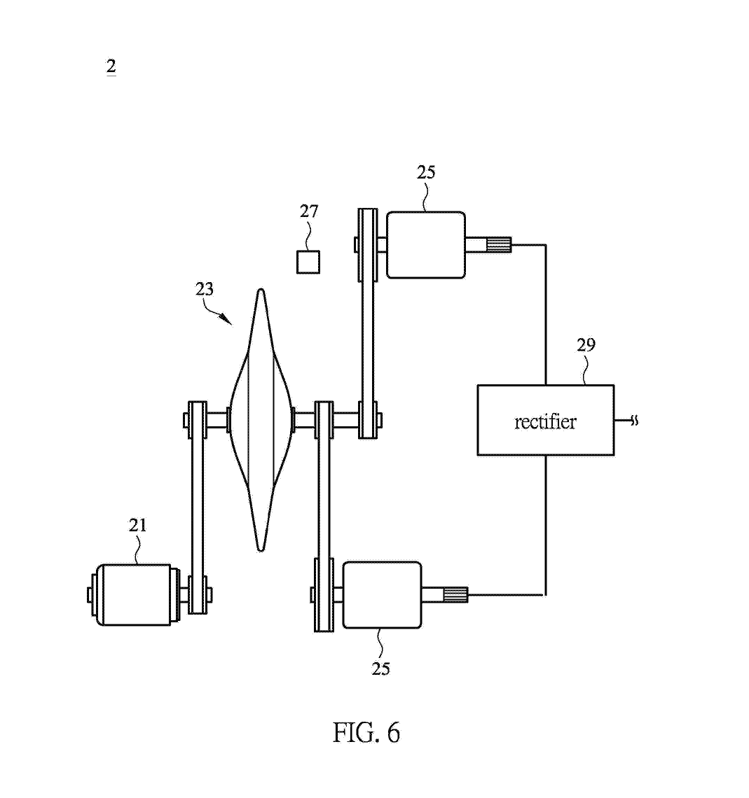

Referring to FIG. 5 and FIG. 6, there are shown a schematic block diagram and a schematic diagram of a system of inertia flywheel assembly in accordance with one embodiment of the present invention. FIG. 6 shows a system in accordance with one embodiment of the system shown in FIG. 5.

The system 2 of inertia flywheel assembly of the present embodiment comprises at least one driving device 21, an inertia flywheel assembly and at least one output device 25.

The driving device 21 is a motor or driving device which provides mechanical energy for driving the inertia flywheel assembly 23. In one embodiment of the invention, the driving device 21 may further comprises a controller (not shown) for controlling the output of the driving device 21. The controller is an optional device in the invention, and is not limitation of the invention.

The inertia flywheel assembly 23 can be but not limited to the aforementioned inertia flywheel assemblies. The inertia flywheel assembly 23 is connected to the driving device 21 and is driven by the driving device 21 that the inertia flywheel(s) starts to spin. FIG. 6 discloses an embodiment of the inertia flywheel assembly 23 with an inertia flywheel. In FIG. 6, the driving device 21 is disposed on the side of the inertia flywheel assembly 23 opposite to the output device 25. In the other embodiment, the driving device 21 and the output device 25 may be disposed on the same side of the inertia flywheel assembly 23 for compact or small system.

In the present invention, according to the requirements of the load, the driving device 21 is designed appropriately. By using the transmission member with different diameters, the rotating speeds of the inertia flywheel assembly 23, the driving device 21 and the output device 25 are different. For example, if the transmission member is belt pulley set, assume that the diameter of the belt pulley on the driving device side is half of the diameter of the belt pulley on the inertia flywheel side, the rotating speed of the driving device is double of the rotating speed of the inertia flywheel.

In one embodiment of the invention, the system 2 may comprises a flywheel monitor unit 27 is used for determining the rotating speed of the at least one inertia flywheel of the inertia flywheel assembly 23. The flywheel monitor unit 27 is a contacting or inducting tachometer. The at least one output device 25 is connected to the inertia flywheel assembly 23. The output device 25 may be an electric generator. In one embodiment, the inertia flywheel assembly 23 is coupled to an electronic device or a battery for storing energy. In the present embodiment, an inertia flywheel is coupled to two output devices 25. The flywheel monitor unit 27 is an optional device in the invention, and is not limitation of the invention.

For example, an inertia flywheel with diameter of 74 cm and weight of 240 kg provides power of 9 Kw at rotating speed of 1800 rpm, power of 17 Kw at rotating speed of 2400 rpm or power of 4 Kw at rotating speed of 1200 rpm.

Furthermore, the embodiment shown in FIG. 6 further comprises an electrical control unit 29. The electrical control unit 29 is selectively one of a rectifier, a regulator, a transformer, regulating/rectifying unit or voltage/current transforming unit. The electrical control unit 29 receives electric energy and provides the electric energy to the system itself or the other device. The other device may be an electric grid.

In practical operation, the controller (not shown) controls the driving device 21 to provide an initial output to the inertia flywheel assembly 23. The initial output depends on the amount and the weights of the inertia flywheels in the inertia flywheel assembly 23. The initial output overcomes the starting static friction force of the inertia flywheel assembly 23 (the total static friction force of the assembly) and drives the inertia flywheels of the assembly 23 to start to spin. However, there are friction forces other than the starting static friction force of the inertia flywheel assembly 23, such as friction force of the bearings and the axle cores, but they are not the points of the present invention.

In one embodiment of the invention, the flywheel monitor unit 27 monitors the inertia flywheel assembly 23 continuously. Once the rotating speed of the inertia flywheel in the inertia flywheel assembly 23 is raised to a rated revolution, the flywheel monitor unit 27 transmits an adjusting signal to the controller (not shown) to adjust the output of the driving device. The adjusted output is lower than the initial output, since the initial output needs to overcome the starting static friction force of the inertia flywheel assembly 23 which is much greater than the dynamic friction force after starting. The output of the driving device 21 is adjusted to maintain the system 2 to operate. The flywheel monitor unit 27 is an optional device in the invention, and is not limitation of the invention.

Comparing to the conventional dynamic device, the system 2 of inertia flywheel assembly of the present invention provides an initial output to start the inertia flywheel assembly 23, and then the output of the driving device 21 is greatly reduced to maintain the operation of the system 2. Consequently, the energy consumption of the system 2 of the present invention is much lower than the conventional dynamic system.

For example, if the present invention is applied to the solar power system, the driving device 21 is the combination of solar panels, motor and regulating/rectifying unit. The electric energy obtained by the solar panels is stored in a battery via the regulating/rectifying unit, and then is provided to the motor to start and maintain the operation of the system 2 of inertia flywheel assembly. The energy stored in the system 2 of the present invention can further provide to output devices (such as electric generator). After the rotating speed of the inertia flywheel is raised to the rated revolution, the output of the solar power system is greatly reduced, and then the electric energy obtained by the solar panels and the system 2 may be stored in a battery or provided to other loads or the electric grid.

If the present invention is applied to the hydraulic power system or wind drive power system, the driving device 21 is the water turbine of the hydraulic power system or wind turbine of the wind drive power system. If the present invention is applied to renewable energy power system, the driving device 21 is the internal combustion engine.

In one embodiment of the present invention, the system 2 further comprises a system monitor unit for monitoring the statuses of the at least one driving device, the inertia flywheel assembly and the at least one output device. The system monitor unit is used to prevent the inertia flywheel from stalling or dropping out because of jitter or anomaly.

For example, the system monitor unit may connect to the flywheel monitor unit 27 to monitor the rotating speed of the inertia flywheel in the inertia flywheel assembly 23. In one embodiment, the system monitor unit can also monitor all or a part of rotary members. The system monitor unit may be a vibration monitor unit for monitoring the vibration of the axle core of the inertia flywheel or the vibration of the system 2. The system monitor unit can also be connected to the output device to monitor the operation status, electric power and output of the system.

Moreover, the system monitor unit can be remotely controlled by wireless network, Bluetooth or infrared. In one embodiment, a plurality of system monitor units of different systems can be connected to a center monitor to monitor a plurality of systems at once.

The present invention further comprises an abort unit connected to the system monitor unit. When the system monitor unit detects an anomalous condition, the abort unit is triggered by the system monitor unit to stop the system.

In particular, when the system monitor unit detects over-speed of the inertia flywheel, anomalous vibration of the axle core, anomalous vibration of the flywheel body, dropping or shift of the axle core, over-vibration of the system plane, or anomalous output of the output device, the system monitor unit transmits an anomalous signal to the abort unit, and the abort unit transmits an abort signal to the at least one driving device or directly stop the operation of the inertia flywheel assembly to prevent the system from accident. After stopping, the system can be repaired by engineers.

Furthermore, the system can further comprise a plurality of dampers (not shown) for reducing the vibration of the system. The situations of axle core shift or assembly shift can be reduced. The energy consumption caused by system vibration can also be reduced and the efficiency of the system is improved. The dampers are disposed on the inertia flywheel assembly or the housing of the system to reduce vibration. Moreover, the dampers can also prevent the system from being damaged during an earthquake.

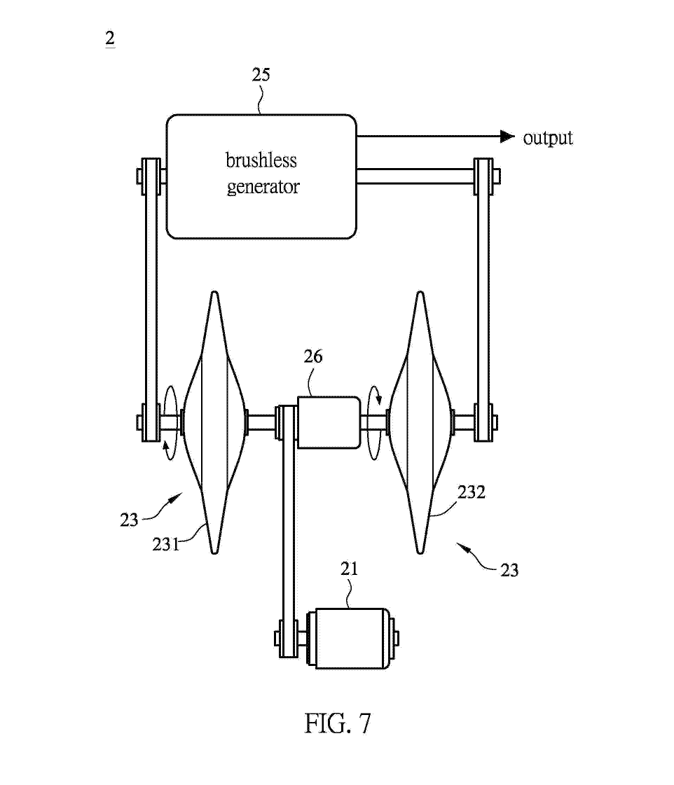

Referring to FIG. 7, there is shown a schematic diagram of a system in accordance with another embodiment of the system shown in FIG. 5. The system 2 of the present embodiment comprises at least one driving device 21, an inertia flywheel assembly 23, a flywheel monitor unit (not shown) and at least one output device 25. In the present embodiment, the output device 25 is a brushless generator.

In the present embodiment, the inertia flywheel assembly 23 comprises two inertia flywheels, such as the first inertia flywheel 231 and the second inertia flywheel 232. The present embodiment further comprises an inverse member 26 having a plurality of gears. The driving device 21 drives the inverse member 26. The gears in the inverse member are connected to the first inertia flywheel 231 and the second inertia flywheel 232 to drive the first inertia flywheel 231 and the second inertia flywheel 232 to spin in reverse directions. The first inertia flywheel 231 and the second inertia flywheel 232 are connect to a magnetic rotor and an armature rotor of the brushless generator (output device 25) to drive the magnetic rotor and the armature rotor to spin in reverse directions. Comparing to the conventional generator, the generator of the present embodiment produces much electric energy by cutting much greater amount of magnetic lines than the conventional generator, since the relative rotating speed is double of the conventional generator.

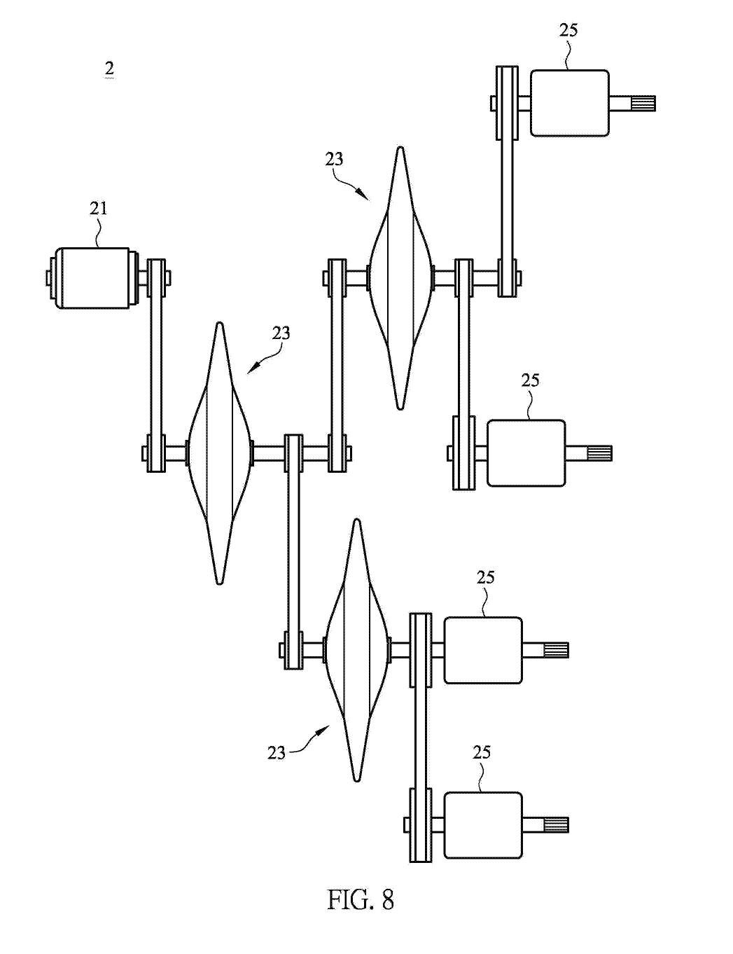

Referring to FIG. 8, there is shown a schematic diagram of a system in accordance with still another embodiment of the system shown in FIG. 5. The system 2 of the present embodiment comprises at least one driving device 21, an inertia flywheel assembly 23, a flywheel monitor unit (not shown) and at least one output device 25.

The inertia flywheel assembly 23 of the present embodiment comprises three inertia flywheels disposed uncoaxially. Two of the inertia flywheels are connected to two output devices 25 respectively.

The plurality of output devices 25 are connected to electrical control unit (not shown). The electric energy generated by the output devices 25 is stored to batteries, transmits to the system itself or output to other device via the electrical control unit. The other device may be an electric grid.

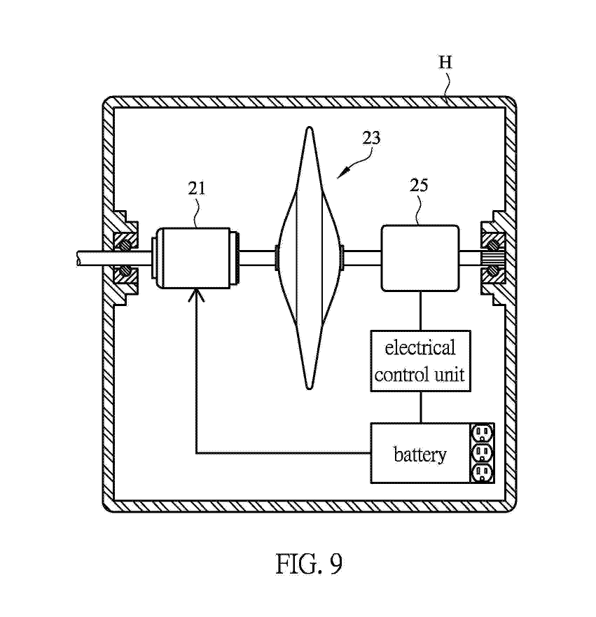

Referring to FIG. 9, there is shown a schematic diagram of a system in accordance with still another embodiment of the system shown in FIG. 5. In the present embodiment, the driving device 21 is directly connected to one inertia flywheel of the inertia flywheel assembly 23. Moreover, the driving device 21, the inertia flywheel assembly 23 and the output device 25 are integrated to a single member. The single member further comprises an electrical control unit 29 and a battery. The output device 25 is connected to the electrical control unit 29. The electric energy generated by the output device 25 is stored in the battery via the electrical control unit 29. A plurality of sockets are disposed on the battery to output electric energy to other device or the driving device 21. The driving device 21 can provide mechanical energy to the inertia flywheel assembly 23 or output mechanical energy to other device. The configuration of the single member can be coupled to other conventional modules to receive or provide mechanical energy.

In summary, by using the present invention, the output of the driving device is greatly reduced after the rotating speed of the inertia flywheel is raised to the rated revolution that greatly reduces the energy consumption of the conventional dynamic system and improves efficiency of the generator system.

The flywheel body of the inertia flywheel in the present invention is an arc-shaped plate with a buckled center portion and a flat surrounding portion which is novel and different from the conventional inertia flywheel. The design of the inertia flywheel assembly and the system thereof of the present invention provides much higher efficiency than the conventional design and should be inventive. Furthermore, the function and efficiency of the inertia flywheel assembly and the system thereof of the present invention are all experimentally proved to be functional for business operation.

What are described above are merely embodiments of the present invention, and are not intended to limit the implementation scope of the present invention. Equivalent variations and modifications made without departing from the shape, structure, feature, method and spirit described in the scope of the claims of the present invention shall all fall within the scope of the claims of the present invention.

What is claimed is:

1. An inertia flywheel assembly, comprising:
at least one inertia flywheel having a flywheel body and a axle core, wherein the axle core is fixed to an axis of the flywheel body and the flywheel body could spin via the axle core; and
at least one transmission member coupled to the axle core of one of the least one inertia flywheel;
wherein the flywheel body is an arc-shaped plate with a first curved surface and a second curved surface, each curved surface has a tangent plane and the two tangent planes include an angle.

2. The inertia flywheel assembly as claimed in claim 1, wherein the angle is between 5 degree and 70 degree.

3. The inertia flywheel assembly as claimed in claim 2, wherein the angle is between 10 and 40 degree.

4. The inertia flywheel assembly as claimed in claim 1, wherein the at least one transmission member comprises a first transmission member, the at least one inertia flywheel comprises a first inertia flywheel and at least one second inertia flywheel, and the first inertia flywheel is coupled to the second inertia flywheel by the first transmission member.

5. The inertia flywheel assembly as claimed in claim 4, wherein the first inertia flywheel and the second inertia flywheel are configured to be coaxial or uncoaxial.

6. The inertia flywheel assembly as claimed in claim 1, wherein the at least one transmission member comprises a first transmission member and a second transmission member, the at least one inertia flywheel comprises a first inertia flywheel, a second inertia flywheel and a third inertia flywheel, and the first inertia flywheel is coupled to the second inertia flywheel and the third inertia flywheel by the first transmission member and the second transmission member respectively.

7. The inertia flywheel assembly as claimed in claim 6, wherein the first inertia flywheel, the second inertia flywheel and the third inertia flywheel are configured to be partially coaxial, coaxial or uncoaxial.

8. The inertia flywheel assembly as claimed in claim 1, wherein the at least one transmission member comprises a plurality of transmission members, the at least one inertia flywheel comprises a plurality of inertia flywheels, and the plurality of inertia flywheels are coupled by the plurality of transmission members.

9. The inertia flywheel assembly as claimed in claim 1, wherein the transmission member is belt pulley set, chain pulley set or gear set.

10. The inertia flywheel assembly as claimed in claim 1, wherein the flywheel body is a monolithic metal member or composed of a plurality of sheet materials.

11. The inertia flywheel assembly as claimed in claim 1, wherein the flywheel body has a diameter and a thickness, and the diameter is greater than the thickness.

12. The inertia flywheel assembly as claimed in claim 1, wherein the flywheel body has a buckled center portion and a flat surrounding portion.

13. The inertia flywheel assembly as claimed in claim 12, the flywheel body has a thickness decreasing form a center of the flywheel body to a circumference of the flywheel body.

14. A system of inertia flywheel assembly, comprising:
at least one driving device;
the inertia flywheel assembly as claimed in claim 1 connected to the at least one driving device; and
at least one output device connected to the inertia flywheel assembly.

15. The system as claimed in claim 14, wherein the at least one driving device is directly connected to one inertia flywheel of the inertia flywheel assembly.

16. The system as claimed in claim 14, wherein the at least one driving device, the inertia flywheel assembly and the at least one output device are integrated to a single member.

17. The system as claimed in claim 14, wherein the at least one output device comprises a plurality of output devices.

18. The system as claimed in claim 14, further comprising an electrical control unit.

19. The system as claimed in claim 14, further comprising a system monitor unit for monitoring a status of the at least one driving device, the inertia flywheel assembly and the at least one output device.

20. The system as claimed in claim 19, further comprising an abort unit connected to the system monitor unit, wherein when the system monitor unit transmits an anomalous signal to the abort unit, the abort unit transmits an abort signal to the at least one driving device or directly stop the inertia flywheel assembly.

21. The system as claimed in claim 19, further comprising a plurality of dampers.

22. The system as claimed in claim 14, further comprising at least one flywheel monitor unit configured to detect the rotating speed of the at least one inertia flywheel in the inertia flywheel assembly, wherein the driving device includes a controller for controlling an output of the driving device, and the controller controls the driving device to provide an initial output to start the inertia flywheel assembly, and when a rotating speed of the inertia flywheel in the inertia flywheel assembly is raised to a rated revolution, the flywheel monitor unit transmits an adjusting signal to the controller to adjust the output of the driving device.
